(19) United States
(12) Patent Application Publication
(10) Pub. No.: US 2025/0173081 A1
(43) Pub. Date: May 29, 2025

(54) STORAGE APPARATUS AND MIGRATION VERIFICATION METHOD

(71) Applicant: Hitachi, Ltd., Tokyo (JP)

(72) Inventors: Soichi WATANABE, Tokyo (JP); Mitsuo Hayasaka, Tokyo (JP); Tsukasa Shibayama, Tokyo (JP)

(73) Assignee: Hitachi, Ltd., Tokyo (JP)

(21) Appl. No.: 18/588,732

(22) Filed: Feb. 27, 2024

(30) Foreign Application Priority Data
Nov. 27, 2023 (JP) 2023-200208

(51) Int. Cl. G06F 3/06

(52) U.S. Cl. CPC G06F 3/0647; G06F 3/0604; G06F 3/0679

(57) ABSTRACT

Operation verification is effectively performed upon migration between interfaces utilizing a storage apparatus having a drive apparatus for storing data and for execution of at least one script. The storage apparatus includes an old program invoked and executed by a pre-migration script, a new program invoked and executed by a post-migration script, an operation control part configured to control a first operation on the drive apparatus in response to a first instruction corresponding to a request from the old program and a second operation on the drive apparatus in response to execution of a second instruction corresponding to a request from the new program, and a migration verification part configured to, in a case where the first instruction satisfies a predetermined condition in relation to the second instruction, the migration verification part determines that migration from the pre-migration script to the post-migration script is successfully performed.

### BACKGROUND OF THE INVENTION

### 1. Field of the Invention

The present invention relates to a storage apparatus and a migration verification method. More particularly, this invention is advantageously adapted to a storage apparatus in conjunction with a technology for verifying the migration from one script to another with use of multiple application program interfaces (API) offered to users by the storage apparatus.

### 2. Description of the Related Art

In recent years, it has become general practice to automatize the operation management of storage systems by using external applications. Accordingly, there are cases where migration is performed from the API offered in the past to the outside by the storage system (referred to as an “old API” hereunder) to a simple, easy-to-use new API (referred to as a “new API”) so as to make it easier for the external applications to utilize the functions of the storage system.

A storage vendor offering APIs to the outside of a storage system for migration from the old API to the new API generally sets up a transition period allowing users of the APIs to smoothly migrate from an old API environment to a new API environment. Here, the transition period is a period during which the old API and the new API are offered concurrently. During this period, the users migrate from the application (referred to as an “old program”) having operated and managed the storage system with use of the old API to the application (referred to as a “new program”) that will operate and manage the storage system with use of the new API. Specifically, the user retrieves from the old program the codes having used the old API targeted for migration and, by studying the external specifications of the old and new APIs, for example, replaces the retrieved codes with new codes that will use the new API. Thereafter, operation verification is performed to determine whether the new program behaves as expected.

The tasks involved in the migration can put enormous workload on the users. This requires the storage vendor to offer various kinds of support for the users to migrate from the old program to the new program with a reduced workload. The technology disclosed in JP-2021-68067-A may improve external specifications, or even interfaces, so as to enhance user-friendliness following the storage system update.

### SUMMARY OF THE INVENTION

However, with the technology disclosed in JP-2021-68067-A, the changes in the interfaces are often cumbersome to check during the operation verification following the migration due to the changes in the external specifications. As a result, the operation verification is not carried out effectively.

The present invention has been made in view of the above circumstances and proposes a storage apparatus and a migration verification method for performing operation verification effectively upon migration from one interface to another.

In achieving the foregoing and other objects of the present invention and according to one aspect thereof, there is provided a storage apparatus having at least one drive apparatus that is able to store data and operating the drive apparatus with respect to the data therein in response to execution of at least one script. The storage apparatus includes an old program invoked and executed by a pre-migration script among the scripts, a new program invoked and executed by a post-migration script among the scripts, an operation control part configured to control a first operation on the drive apparatus in response to execution of a first instruction corresponding to a request from the old program, the operation control part further controlling a second operation on the drive apparatus in response to execution of a second instruction corresponding to a request from the new program, and a migration verification part configured such that, in a case where the first instruction satisfies a predetermined condition for correspondence in relation to the second instruction, the migration verification part determines that migration from the pre-migration script to the post-migration script is successfully performed.

According to another aspect of the present invention, there is provided a migration verification method for use with a storage apparatus having at least one drive apparatus that is able to store data and operating the drive apparatus with respect to the data therein in response to execution of at least one script. The migration verification method includes an old program invoked and executed by a pre-migration script among the scripts, a new program invoked and executed by a post-migration script among the scripts, an operation control part configured to control a first operation on the drive apparatus in response to execution of a first instruction corresponding to a request from the old program, the operation control part further controlling a second operation on the drive apparatus in response to execution of a second instruction corresponding to a request from the new program, and a migration verification part configured such that, in a case where the first instruction satisfies a predetermined condition for correspondence in relation to the second instruction, the migration verification part determines that migration from the pre-migration script to the post-migration script is successfully performed.

The present invention thus makes it possible to carry out operation verification effectively upon migration from one interface to another.

### BRIEF DESCRIPTION OF THE DRAWINGS

FIG. 1 is a software configuration diagram depicting an exemplary system configuration of a storage system having a storage apparatus as a first embodiment of the present invention;

FIG. 2 is a hardware configuration diagram depicting an exemplary hardware configuration of the storage system indicated in FIG. 1;

FIG. 3 is a schematic view depicting an exemplary logical configuration of an input/output (I/O) module indicated in FIG. 1;

FIG. 4 is a block diagram depicting an exemplary logical configuration of a management module indicated in FIG. 1;

FIG. 5 is a tabular view listing an example of an external API-A log indicated in FIG. 4;

FIG. 6 is a tabular view listing an example of a management program A log indicated in FIG. 4;

FIG. 7 is a tabular view listing an example of an I/O module log indicated in FIG. 3;

FIG. 8 is a tabular view listing an example of an old-program log indicated in FIG. 4;

FIG. 9 is a tabular view listing an example of a new-program log indicated in FIG. 4;

FIG. 10 is a flowchart depicting an exemplary procedure of a migration verification process of the first embodiment;

FIG. 11 is a flowchart depicting an exemplary procedure of a log collection process indicated in FIG. 10;

FIG. 12 is a flowchart depicting an exemplary procedure of a process for preparing old-program log correspondence information indicated in FIG. 10;

FIG. 13 is a flowchart depicting an exemplary procedure of an entry comparison process indicated in FIG. 10;

FIG. 14 is a schematic view depicting an exemplary logical configuration of a management module in a second embodiment of the present invention;

FIG. 15 is a tabular view listing exemplary predefined log mapping rules indicated in FIG. 14; and

FIG. 16 is a flowchart indicating an exemplary procedure of a migration verification process of the second embodiment.

### DESCRIPTION OF THE PREFERRED EMBODIMENTS

Some preferred embodiments of the present invention are described below in detail with reference to the accompanying drawings.

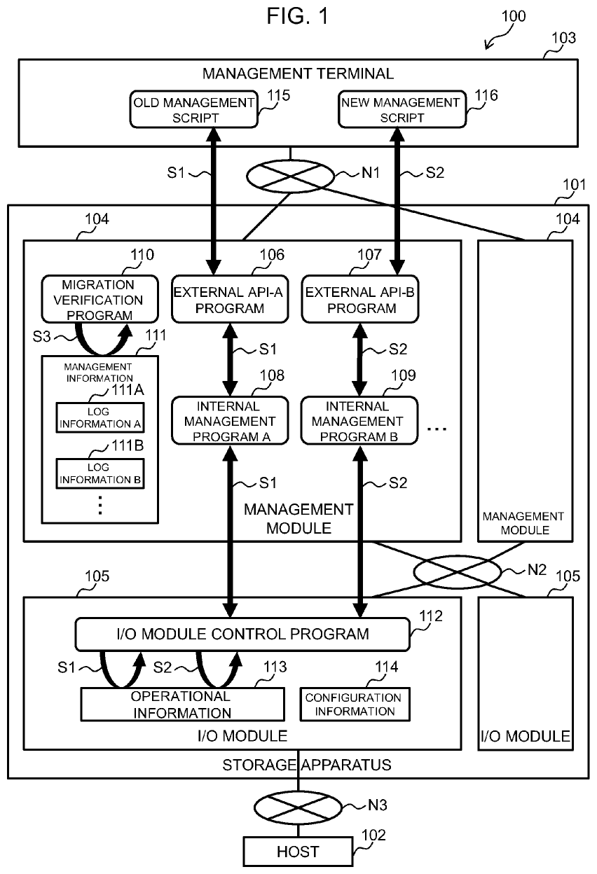

FIG. 1 is a software configuration diagram depicting an exemplary system configuration of a storage system 100 having a storage apparatus 101 as a first embodiment of the present invention. The constituent elements of the system and the processes performed will be described later in detail.

The storage apparatus 101 has at least one drive apparatus capable of storing data as will be discussed later. The storage apparatus 101 operates the drive apparatus with respect to the data therein in response to execution of at least one script. The storage system 100 includes the storage apparatus 101, at least one host 102, and at least one management terminal 103. The storage apparatus 101, the host 102, and the management terminal 103 are connected with one another via an external network N1.

The storage apparatus 101 is an apparatus which provides the host 102 with storage regions for writing and reading data and which includes at least one management module 104 and at least one I/O module 105. The management module 104 and the I/O module 105 are connected with each other via an internal network N2 inside the storage apparatus 101. For simplicity of explanation, an example is explained here in which one management module 104 and one I/O module 105 are provided in this embodiment unless otherwise noted.

The management module 104 includes an external API-A program 106 and an internal management program A 108 as exemplary old programs to be invoked and executed by a pre-migration script among scripts, and an external API-B program 107 and an internal management program B 109 as exemplary new programs to be invoked and executed by a post-migration script among the scripts. For this embodiment, an example is explained here in which there are two old programs and two new programs targeted for migration. However, this is not limitative of the present invention. Alternatively, there may be one old program and one new program.

The above-mentioned old programs include, for example, the external API-A program 106 as an example of a first external management program to be invoked and executed by the pre-migration old script among the scripts, and the internal management program A 108 as an example of a first internal management program to be invoked and executed by the external API-A program 106. Meanwhile, the above-mentioned new programs include, for example, the external API-B program 107 as an example of a second external management program to be invoked and executed by the new script replacing the old one among the scripts, and the internal management program B 109 as an example of a second internal management program to be invoked and executed by the external API-B program 107.

The management module 104 includes the external API-A program 106, the external API-B program 107, at least two internal management programs, a migration verification program 110, and management information 111. The management module 104 is connected to the management terminal 103 via the external network N1.

The migration verification program 110 is an example of a migration verification part. In a case where a first instruction for executing a first operation on the drive apparatus in response to a request from the old program satisfies a predetermined condition for correspondence in relation to a second instruction for executing a second operation on the drive apparatus in response to the request from the new program, the migration verification program 110 determines that migration is successfully performed from the pre-migration script to the post-migration script.

When a migration verification processing part 404 of the migration verification program 110 is not in a mode in which a new management script 116 can be executed (the mode will be referred to as a “new script execution mode” hereunder), the management terminal 103 can issue a request for switchover to a mode in which an old management script 115 can be executed (the mode will be referred to as an “old-script execution mode” hereunder). The management terminal 103 may terminate the old-script execution mode as needed. Also, when the old-script execution mode is not in effect, the management terminal 103 may issue a request to the migration verification processing part 404 of the migration verification program 110 for switchover to the new script execution mode. The management terminal 103 may terminate the new script execution mode as needed.

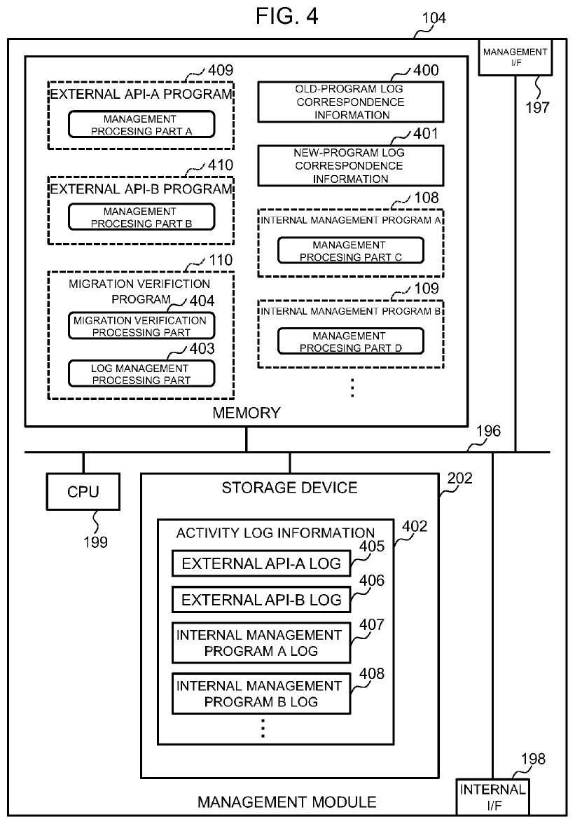

Upon receipt of a configuration setting operation and an operational information collection operation issued from the management terminal 103 via the external API-A program 106 or the external API-B program 107, the management module 104 relays the configuration setting operation and the operational information collection operation to the internal management program. When receiving the configuration setting operation and the operational information collection operation from various APIs with the external API-A program 106 and the external API-B program 107, the internal management program relays the received configuration setting operation and operational information collection operation to the I/O module 105 via the internal network. Although not explained here, the management module 104 has constituent elements other than those described above. The whole range of the constituent elements will be discussed later with reference to FIG. 4.

The external API-A program 106 and the external API-B program 107 may each be a web application-oriented API such as the Representational State Transfer API (REST API) or a user interface such as the Command Line Interface (CLI), for example.

The management information 111 includes log information A 111A as an example of first activity log information corresponding to the first operation and log information B 111B as an example of second activity log information corresponding to the second operation. The management information 111 further includes an I/O module log 300 as an example of third activity log information corresponding to execution of the first instruction by an I/O module control program 112 exemplifying the operation control part and as an example of fourth activity log information corresponding to execution of the second instruction by the I/O module control program 112.

The I/O module 105 in the storage apparatus 101 is a module that performs data input and output by processing a data read request and a data write request transmitted from the host 102. The I/O module 105 includes the I/O module control program 112, operational information 113, and configuration information 114.

The I/O module control program 112 performs processes corresponding to the data read request and the data write request from the host 102. The I/O module control program 112 is an example of the operation control part. The I/O module control program 112 controls the first operation on the drive apparatus in response to execution of the first instruction corresponding to a request from the above-mentioned old program, and also controls the second operation on the drive apparatus in response to execution of the second instruction corresponding to a request from the above-mentioned new program.

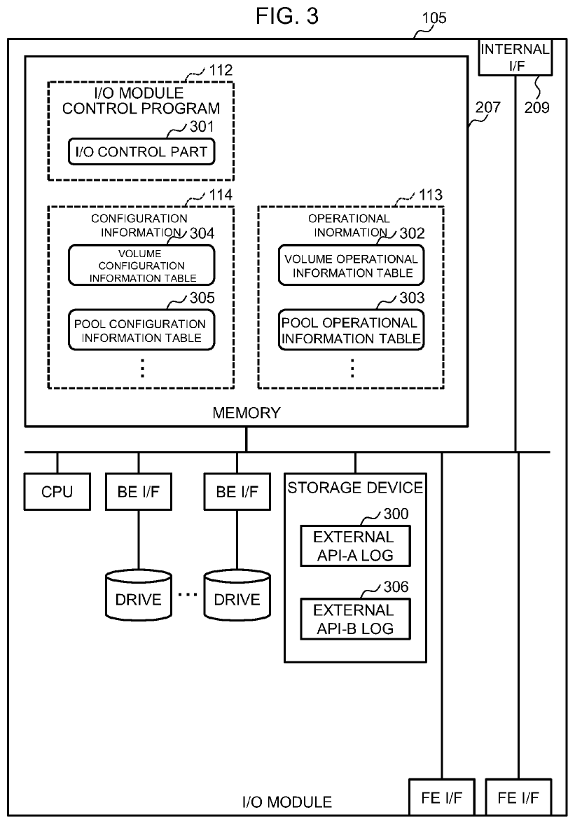

In addition, the I/O module control program 112 performs the process of transferring the operational information 113 and the configuration information 114 in response to a request from the management module 104. Incidentally, the I/O module 105 has constituent elements other than those described above. The whole range of the constituent elements will be discussed later with reference to FIG. 3. The I/O module 105 also performs processes other than those described above. The whole range of the processes will also be discussed later with reference to FIG. 3.

The management terminal 103 has management programs for operating and managing the storage apparatus 101. For example, the management programs are scripts that make use of the external API-A program 106 and the external API-B program 107. In communicating with the storage apparatus 101, the management programs request the storage apparatus 101 to operate on the configuration settings or to acquire the operational information thereof for monitoring purposes.

The host 102 is a computer that performs various operational processes by executing installed programs. In response to a request from a running program, the host 102 transmits at least either a data read request or a data write request to the storage apparatus 101.

The storage system 100 is configured as described above. What follows is an overall explanation of how the storage system 100 typically operates. FIG. 1 indicates steps S1, S2, and S3 that make up an overall procedure of the entire processing of the first embodiment.

In step S1, the old management script 115 executes a series of programs for operating and managing the storage apparatus 101. During the execution, the old management script 115 transmits a request to the external API-A program 106 for the configuration setting operation or for the operational information collection operation as needed.

The external API-A program 106 executes the configuration setting operation or the operational information collection operation by communicating with the I/O module control program 112 with use of the internal management program A 108, for example. At this time, the external API-A program 106, the internal management program A 108, and the I/O module control program 112 each issue an execution log (e.g., log information A 111A, log information B 111B, I/O module log 300) for analyzing the functions they have executed.

Here, the internal management program for use by the external API-A program 106 need not be limited to the internal management program A 108 alone and may be some other internal management program. Also, the APIs of the external API-A program 106 may each use a different internal management program.

In step S2, the new management script 116 executes a series of programs for operating and managing the storage apparatus 101. During the execution, the new management script 116 transmits a request to the external API-B program 107 for the configuration setting operation or for the operational information collection operation as needed.

The external API-B program 107 executes the configuration setting operation or the operational information collection operation by communicating with the I/O module control program 112 with use of the internal management program B 109, for example. At this time, the external API-B program 107, the internal management program B 109, and the I/O module control program 112 each issue an execution log for analysis of the functions that they have executed.

Here, the internal management program for use by the external API-B program 107 need not be limited to the internal management program B 109 alone and may be some other internal management program. Also, the APIs of the external API-B program 107 may each use a different internal management program.

In step S3, the migration verification program 110 verifies the logs issued in steps S1 and S2. In so doing, the migration verification program 110 determines whether there is correspondence between the external API-A program 106 and the external API-B program 107 for use by the old management script 115 and by the new management script 116, respectively.

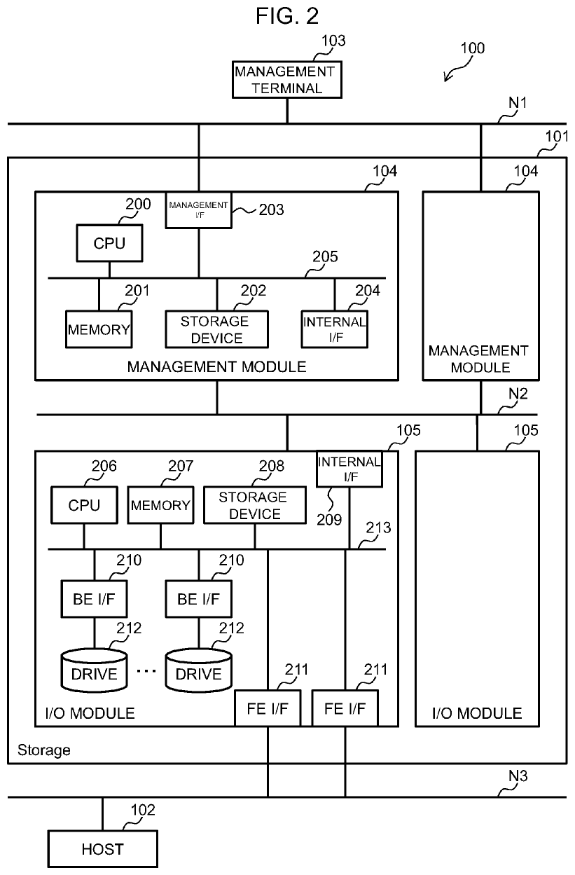

FIG. 2 is a hardware configuration diagram depicting an exemplary hardware configuration of the storage system 100 indicated in FIG. 1. The storage system 100 includes the storage apparatus 101, at least one host 102, and at least one management terminal 103.

The storage apparatus 101 and the management terminal 103 are connected to the external network N1 and can communicate with each other over the external network N1. The external network N1 is configured with one combination or a of appropriate communication lines including an optical fiber network, a long-term evolution (LTE) network, a fifth-generation mobile communication system (5G), and a wireless local area network (LAN).

The management terminal 103 is an apparatus by which a user operates the storage apparatus 101. An example of the management terminal 103 is a laptop computer.

The host 102 is connected to the storage apparatus 101 via a storage network N3. The storage network N3 may be configured with a storage area network (SAN) using fiber channels (FC). Alternatively, the storage network N3 may be configured with an Internet Small Computer System Interface (isCSI) that uses the Ethernet or InfiniBand, for example.

The host 102 is a computer that performs various operational processes by executing installed programs. In response to a request from a running program, the host 102 transmits at least either a data read request or a data write request to the storage apparatus 101.

The storage apparatus 101 includes at least one management module 104 and at least one I/O module 105. The management module 104 and the I/O module 105 are connected with each other via the internal network N2 inside the storage apparatus 101. The internal network N2 may be configured with the Ethernet, PCI Express, or InfiniBand, for example.

The management module 104 includes at least one central processing unit (CPU) 200, at least one memory 201, at least one storage device 202, at least one management interface (I/F) 203, and at least one internal I/F 204. These constituent elements are connected with one another via a bidirectionally communicable bus 205.

The CPU 200 implements various processes by executing diverse programs stored in the memory 201. The memory 201 stores information for controlling the various programs and the management module 104. The memory 201 may be configured with a dynamic random access memory (DRAM).

The storage device 202 is a nonvolatile storage device that stores an operating system (OS) image and activity logs of the management module 104. An example of the storage device 202 is a hard disk drive (HDD) or a solid-state drive (SSD).

The management I/F 203 is a network I/F communicating with the external component that manages the storage apparatus 101. An exemplary external component managing the storage apparatus 101 operates on the management terminal 103. The management I/F 203 may include a network interface card (NIC) supporting the Ethernet. Alternatively, the management I/F 203 may include a suitable network interface device supporting the communication standard of the external network N1.

The internal I/F 204 is a network interface that communicates with the I/O module 105 or with another management module 104. The internal I/F 204 includes a suitable network interface device supporting the communication standard of the internal network N2.

The I/O module 105 includes at least one CPU 206, at least one memory 207, at least one storage device 208, at least one internal I/F 209, at least one back-end (BE) I/F 210, at least one front-end (FE) I/F 211, and at least one drive 212. The CPU 206, the memory 207, the BE I/F 210, the FE I/F 211, and the internal I/F 209 are connected with each other via a bidirectionally communicable bus 213.

The CPU 206 implements various processes by executing diverse programs stored in the memory 207. The memory 207 stores information for controlling the diverse programs and the I/O module 105. The memory 207 may be configured with a DRAM.

The internal I/F 209 is a network interface that communicates with the management module 104 and with another I/O module 105. The internal I/F 209 includes a suitable network interface device supporting the communication standard of the internal network N2. Whereas the illustrated example is an example in which the I/O module 105 has one internal I/F 209, the I/O module 105 may have an internal I/F and an internal network dedicated to ensuring communication between the I/O modules. In this case, the communication standard used between the I/O modules may differ from the communication standard between the I/O module 105 and the management module 104.

The FE I/F 211 is a network interface that connects the I/O module 105 to the storage network N3 and to the host 102. The FE I/F 211 includes a network interface device supporting the communication standard of the storage network N3.

The drive 212 is an apparatus that has physical storage regions. For example, the drive 212 is configured with a nonvolatile storage apparatus such as an HDD, an SSD, a storage class memory (SCM), or an optical disk. The drive 212 is connected to the BE I/F 210 via an interface such as the Serial Attached SCSI (SAS), Serial Advanced Technology Attachment (SATA), or Non-Volatile Memory Express (NVMe). Although not depicted, one drive 212 may be connected with the BE I/Fs 210 of multiple I/O modules 105.

Although not indicated, the I/O module 105 may be configured in such a manner that data is not simply written to the drive 212 but is written to a Redundant Array of Independent Disks (RAID) group constituted by a high-reliability technology known as the RAID bundling multiple drives 212.

In addition to the above-described functions, the storage apparatus 101 may have other known functions for use when the data write request or the data read request is issued by the host 102. Although the ensuing paragraphs omit, where appropriate, explanations of the process flow and data structures related to such data input and output processes, the storage apparatus 101 is assumed to be configured to properly perform the data input and output not found in the explanations.

The storage device 208 is a nonvolatile storage device that stores the OS image and log information of the I/O module 105. An example of the storage device 208 is an HDD or an SSD.

Incidentally, at least one of the host 102, the management module 104, and the I/O module 105 need not be limited to a physical component and may be configured using virtualization technologies such as a virtual machine or a container, for example. The host 102, the management module 104, and the I/O module 105 may be virtualized with use of virtualization technologies and configured in a single physical apparatus. In this case, a virtual switch may be used as the internal network N2.

FIG. 3 is a schematic view depicting an exemplary logical configuration of the I/O module 105 indicated in FIG. 1. The memory 207 stores the I/O module control program 112, the configuration information 114, and the operational information 113. The memory 207 is illustrated to store the data related to this embodiment, although the memory 207 may hold some of the data read or written by the I/O module control program 112, by a cache of the configuration information 114, by a cache of the operational information 113, and by the host 102 as well as other diverse kinds of data in addition to the illustrated data.

The I/O module control program 112 is executed by the CPU 206 of the I/O module 105 in the storage apparatus 101. The I/O module control program 112 references and updates the operational information 113, the configuration information 114, and the I/O module log 300 in keeping with processing. An I/O control part 301 is a program that provides the host 102 with volumes and processes data input and output requests with respect to the volumes. In addition, the I/O control part 301 performs processes of transferring the configuration information 114 and the operational information 113 stored in the memory 207 and the I/O module log 300 held in the storage device 208 in response to requests from the management module 104.

The operational information 113 is information indicative of the operational status of the I/O module 105 such as a CPU utilization rate, an input/output per second (IOPS), and a transfer rate. The I/O module control program 112 updates the operational information 113 in a suitably timed manner such as at predetermined intervals or when a data read request or a data write request is issued from the host 102.

A volume operational information table 302 is a table that stores the operational information with respect to individual volumes. A pool operational information table 303 is a table that stores the operational information with regard to individual pools. Although not depicted, the memory may also store tables that store operational information regarding various components such as the host 102, the drive, the FE I/F, the BE I/F, and internal ports in addition to the above tables.

The configuration information 114 is information regarding the configuration of the storage apparatus 101. The configuration information 114 includes a volume configuration information table 304 and a pool configuration information table 305. The volume configuration information table 304 manages the definitions of the individual volumes such as volume identifiers (IDs) and capacities. The pool configuration information table 305 manages the definitions of the individual pools such as pool IDs and capacities. For example, the user of the storage system 100 instructs the storage apparatus 101 to prepare or delete volumes by use of the management terminal 103.

The I/O module control program 112 of the I/O module 105 receives the above instructions via the management module 104 and, while performing suitable processes, adds entries to, deletes entries from, or changes entries in the configuration information as needed.

In another example, the user of the storage system 100 requests the storage apparatus 101 to reference the configuration information with use of the management terminal 103. The I/O module control program 112 receives the request by way of the management module 104, and transfers the configuration information 114 in accordance with the request. Although not depicted, tables for managing the configuration of various components in addition to those discussed above may be stored as the configuration information 114 in the memory 207.

The I/O module log 300 is activity log information regarding the I/O module 105. For example, the names of the program functions executed by the I/O module 105 and the timestamps related to the executions may be stored as the activity log information. Other diverse kinds of activity log information may also be stored.

Log setting information 306 is information regarding the log levels at which the I/O module control program 112 outputs log information and also information regarding the configuration information related to output destinations.

FIG. 4 is a block diagram depicting an exemplary logical configuration of the management module 104 indicated in FIG. 1. The memory 201 stores the external API-A program 106, the external API-B program 107, at least two internal management programs 108 and 109, the migration verification program 110, old-program log correspondence information 400, and new-program log correspondence information 401. The memory 201 is illustrated to store only the management programs and management information related to this embodiment, although the memory 201 may also store other management programs and management information in addition to those illustrated.

The external API-A program 106 and the external API-B program 107 are each a program that receives various configuration setting operations and operational information collection requests from the host 102. The external API-A program 106 and the external API-B program 107 may simply relay the various received requests to the internal management programs 108 and 109.

The internal management programs may simply relay to the I/O module control program 112 the diverse requests received from the external API-A program 106 and from the external API-B program 107. Alternatively, the external API-A program 106, the external API-B program 107, and the internal management programs may perform suitable processes when relaying the received diverse requests.

For example, the external API-A program 106, the external API-B program 107, and the internal management programs may convert the received diverse requests into at least one internal request for use inside the storage apparatus 101 or convert the data structure corresponding to the received requests.

The migration verification program 110 is a program that prepares, from diverse kinds of activity log information 402 in the storage device 202, the old-program log correspondence information 400 and the new-program log correspondence information 401 in order to verify whether there is correspondence between the APIs of the external API-A program 106 to be executed by the old management script 115 on one hand and the APIs of the external API-B program 107 to be executed by the new management script 116 on the other hand, by use of the prepared log correspondence information.

The migration verification program 110 includes a log management processing part 403 and a migration verification processing part 404. The log management processing part 403 performs the process of acquiring the I/O module log 300 from inside the I/O module 105 by communicating with the I/O module control program 112, in order to prepare the old-program log correspondence information 400 and the new-program log correspondence information 401. Also, by use of the old-program log correspondence information 400 and the new-program log correspondence information 401, the migration verification processing part 404 performs a migration verification process of determining whether there is correspondence between the APIs of the external API-A program 106 to be executed by the old management script 115 on one hand and the APIs of the external API-B program 107 to be executed by the new management script 116 on the other hand.

The old-program log correspondence information 400 is information that indicates the relations between the activity logs of three programs: the external API-A program 106, the internal management program to which various requests from the host 102 are relayed by the external API-A program 106, and the I/O module control program 112 to which the various requests are relayed by the internal management program.

For example, the old-program log correspondence information 400 is a table that holds information providing correspondence between the name of a request received from the host 102 by the external API-A program 106, the name of the function executed by the internal management program A 108 after the request has been relayed thereto, and the name of the function executed by the I/O module control program 112 to which the request from the external API-A program 106 has been relayed by the internal management program A 108.

Meanwhile, the new-program log correspondence information 401 is information that indicates the relations between the activity log of the external API-B program 107, the activity log of the internal management program to which various requests from the host 102 have been relayed by the external API-B program 107, and the activity log of the I/O module control program 112 to which the various requests have been relayed by the internal management program.

For example, the new-program log correspondence information 401 is a table that holds information providing correspondence between the name of a request received from the host 102 by the external API-B program 107, the name of the function executed by the internal management program B 109 after the request has been relayed thereto, and the name of the function executed by the I/O module control program 112 to which the request from the external API-B program 107 has been relayed by the internal management program B 109.

The storage device 202 stores an external API-A log 405, an external API-B log 406, and various internal management program logs, as the activity log information.

The external API-A log 405 is information regarding the processes performed by the external API-A program 106 to which various configuration setting operations and operational information collection requests have been issued by the host 102.

The external API-B log 406 is information regarding the processes performed by the external API-B program 107 to which various configuration setting operations and operational information collection requests have been issued by the host 102.

The various internal management program logs include information regarding the processes performed by various internal management programs when the host 102 has issued various configuration setting operations and operational information collection requests to the external API-A program 106 and the external API-B program 107 that in turn relay these requests to the various internal management programs.

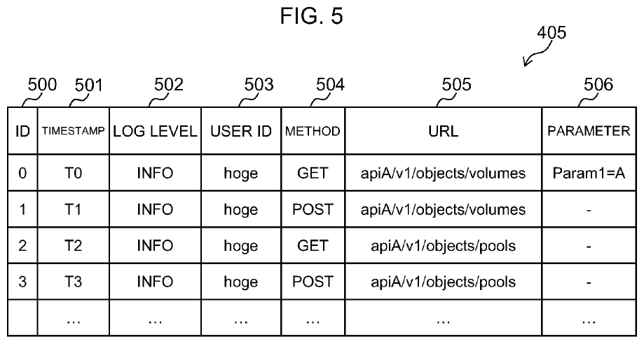

FIG. 5 is a tabular view listing an example of the external API-A log 405 indicated in FIG. 4. Entries in the external API-A log 405 are prepared at every execution of the various APIs of the external API-A program 106.

The external API-A log 405 manages IDs 500, timestamps 501, log levels 502, user IDs 503, methods 504, Uniform Resource Locators (URL) 505, and parameters 506. The external API-A log 405 manages log information regarding the invocation of individual APIs by the external API-A program 106.

The timestamps 501 record information indicative of the time at which a given API is executed by the external API-A program 106. The log levels 502 record information regarding the log level of given log information output by the external API-A program 106 (e.g., a level indicative of whether the log information in question is reference information or warning information). The user IDs 503 record the ID of the user of a given API executed by the external API-A program 106.

The methods 504 record the Hypertext Transfer Protocol (HTTP) method of a given API executed by the external API-A program 106. The URLs 505 record the URL of a given API executed by the external API-A program 106. The parameters 506 record a query parameter and the parameter within a request body for a given API executed by the external API-A program 106.

Although not listed, the external API-B log 406 has information prepared at every execution of the various APIs by the external API-B program 107, the information being also similar to that of the external API-A log 405. The external API-A log 405 explained for this embodiment is only an example. Diverse kinds of activity log information other than the activity log information explained above may also be added as lines in the log.

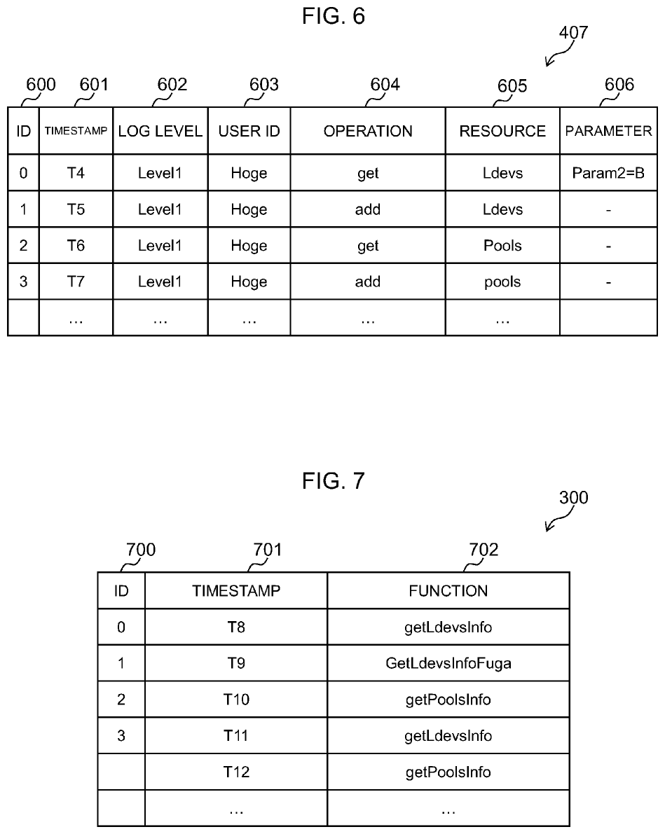

FIG. 6 is a tabular view listing an example of an internal management program A log 407 indicated in FIG. 4. Entries in the internal management program A log 407 are prepared at every execution of the various commands by the internal management program A 108, for example.

The internal management program A log 407 manages IDs 600, timestamps 601, log levels 602, user IDs 603, operations 604, resources 605, and parameters 606. The internal management program A log 407 manages log information regarding the invocation of individual commands by the internal management program A 108.

The timestamps 601 record information indicative of the time at which a given command executed by the internal management program A 108 is invoked. The log levels 602 record the log level of a given log output by the internal management program A 108.

The user IDs 603 record the ID of the user of a given command executed by the internal management program A 108. The operations 604 record the operation type (for example, update, delete, add, or read data; or prepare, delete, or add volume) of a given command executed by the internal management program A 108. The resources 605 record the resource operated by a given command executed by the internal management program A 108.

Here, if the resource is “Pools,” for example, that means the pool configuration information table or the pool operational information table is targeted for operation. In this embodiment, the information that identifies the data targeted for operation is called a “resource.”

The parameters 606 record the parameter of a given command executed by the internal management program A 108. Although not listed, the log information regarding the internal management program B 109 and other various internal management programs that is similar to the information regarding the internal management program A log 407 is also prepared at every execution of various commands by the various internal management programs.

The internal management program A log 407 explained for this embodiment is only an example. Diverse kinds of activity log information other than the activity log information explained above may also be added as lines in the log.

FIG. 7 is a tabular view listing an example of the I/O module log 300 indicated in FIG. 3. Entries in the I/O module log 300 are, for example, prepared at every execution of various functions by the I/O module control program 112 implementing various configuration setting operations and operational information requests relayed thereto from various internal management programs.

The I/O module log 300 manages IDs 700, timestamps 701, and functions 702, for example. The I/O module log 300 manages log information regarding individual functions executed by the I/O module control program 112.

The timestamps 701 record information indicative of the time at which a given function executed by the I/O module control program 112 is invoked. The functions 702 record the name of a given function executed by the I/O module control program 112.

Here, the I/O module log 300 may manage diverse kinds of information, not listed and other than the information explained above, with respect to the execution of the I/O module control program 112. The timing at which a given entry in the I/O module log 300 is prepared is not limited to the timing discussed above. Alternatively, the timing may be varied depending on the log level of the I/O module control program 112, for example.

The I/O module log 300 explained for this embodiment is only an example. Diverse kinds of activity log information other than the above-described activity log information may also be added as lines in the log.

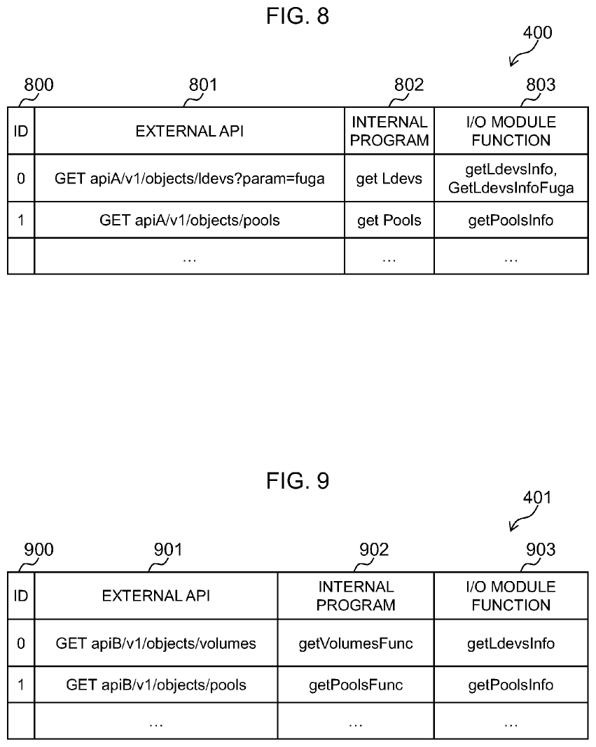

FIG. 8 is a tabular view listing an example of the old-program log correspondence information 400 indicated in FIG. 4. Entries in the old-program log correspondence information 400 are prepared while the migration verification processing part 404 is performing the process of preparing the old-program log correspondence information.

The old-program log correspondence information 400 manages IDs 800, external APIs 801, internal management programs 802, and I/O module functions 803, for example. The old-program log correspondence information 400 manages the relations of correspondence between various APIs, commands, and functions executed by the external API-A program 106, by various internal management programs, and by the I/O module control program 112.

The external APIs 801 record information indicative of the methods, URLs, and parameters of the external API-A program 106. The internal management programs 802 record the operations, resources, and parameters of various internal management programs. The I/O module functions 803 record the names of various functions of the I/O module control program 112.

In this embodiment, the external APIs 801, the internal management programs 802, and the I/O module functions 803 have one-to-one-to-one correspondence therebetween. However, this is only an example. In another example, two I/O module functions may be executed upon execution of one external API.

FIG. 9 is a tabular view listing an example of the new-program log correspondence information 401 indicated in FIG. 4. Entries in the new-program log correspondence information 401 are prepared while the migration verification processing part 404 is performing the process of preparing the new-program log correspondence information.

The new-program log correspondence information 401 manages IDs 900, external APIs 901, internal management programs 902, and I/O module functions 903, for example. The new-program log correspondence information 401 manages the relations of correspondence between various APIs, commands, and functions executed by the external API-B program 107, by various internal management programs, and by the I/O module control program 112.

The external APIs 901 record information indicative of the methods, URLs, and parameters of the external API-B program 107. The internal management programs 902 record the operations, resources, and parameters of various internal management programs. The I/O module functions 903 record the names of various functions of the I/O module control program 112.

In this embodiment, the external APIs 901, the internal management programs 902, and the I/O module functions 903 have one-to-one-to-one correspondence therebetween. However, this is only an example. In another example, two I/O module functions may be executed upon execution of one external API.

The storage system 100 of this embodiment is configured as described above. Explained below with reference to FIGS. 1 through 9 are operation examples of the storage system 100.

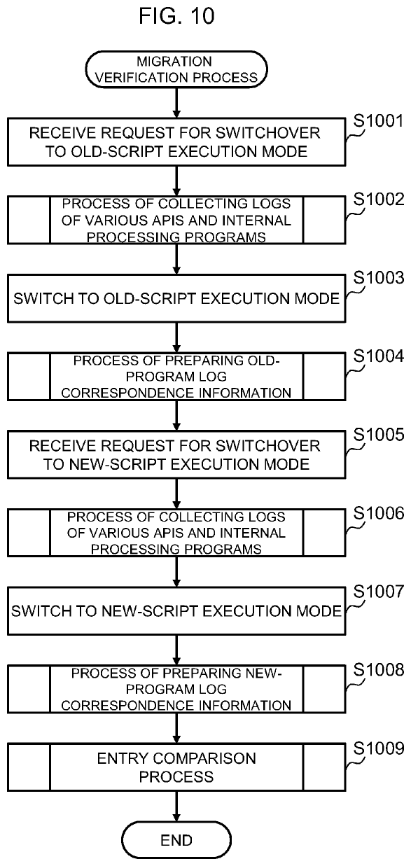

FIG. 10 is a flowchart depicting an exemplary procedure of a migration verification process of the first embodiment. The migration verification process is performed by the migration verification program 110. An outline of the migration verification process is first explained here. This embodiment has two modes: an old-script execution mode as an exemplary pre-migration mode in which the old program is executed in accordance with the old script (i.e., script before migration), and a new-script execution mode as an exemplary post-migration mode in which the new program is carried out in accordance with the new script (script after migration). The migration verification program 110 switches between the old-script execution mode and the new-script execution mode to determine whether migration from the old script to the new script is successfully achieved. The specific steps involved are explained below.

First, in step S1001, the migration verification processing part 404 of the migration verification program 110 receives a request for switchover to the old-script execution mode from the management terminal 103. The migration verification processing part 404 records as a timestamp the time at which the request for switchover to the old-script execution mode is received.

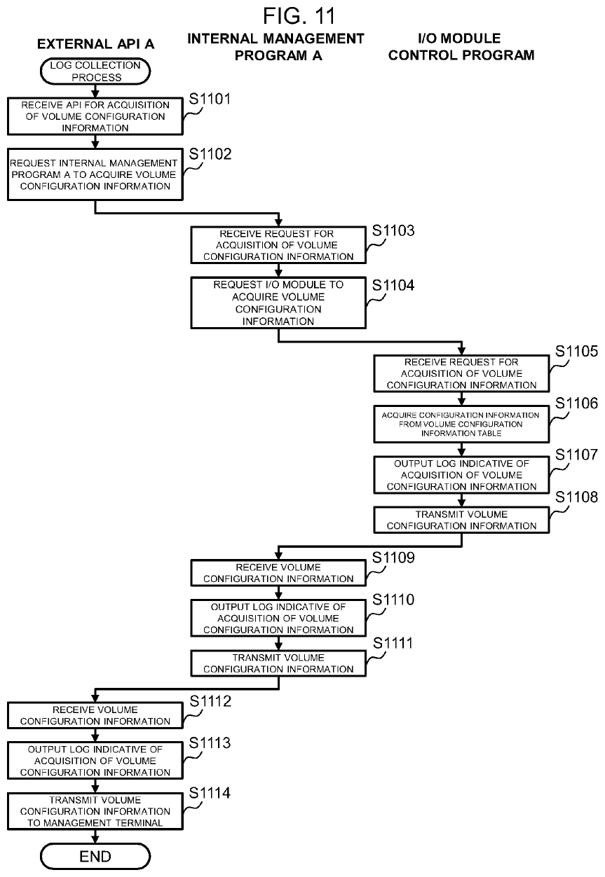

Step S1002 is a process of collecting the logs of various APIs and internal processing programs. In step S1002, the migration verification processing part 404 performs the process of log collection, or more specifically, the log collection process in FIG. 11, to be discussed later.

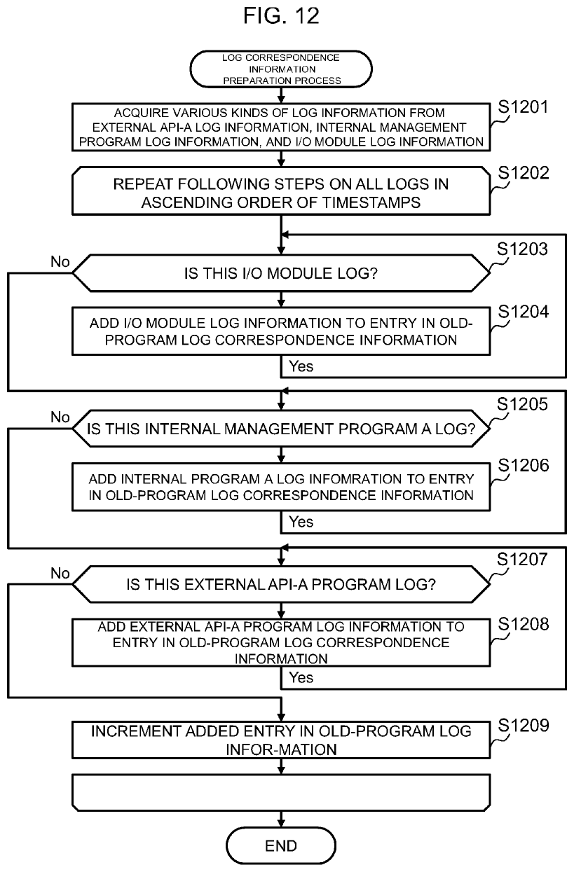

In step S1003, the migration verification processing part 404 switches to the old-script execution mode. Step S1004 is a process of preparing the old-program log correspondence information. In step S1004, the migration verification processing part 404 in the old-script execution mode performs the old-program log correspondence information preparation process in FIG. 12, to be discussed later.

In step S1005, the migration verification processing part 404 receives from the management terminal 103 a request for switchover to the new-script execution mode. The migration verification processing part 404 records as a timestamp the time at which the request for switchover to the new-script execution mode is received.

Step S1006 is a process of collecting the logs of various APIS and internal processing programs. In step S1006, the migration verification processing part 404 in the new-script execution mode performs the log collection process in FIG. 11, to be discussed later.

In step S1007, the migration verification processing part 404 switches to the new-script execution mode. Step S1008 is a process of preparing the new-program log correspondence information. In step S1008, the migration verification processing part 404 performs the new-program log correspondence information preparation process in FIG. 12, to be discussed later.

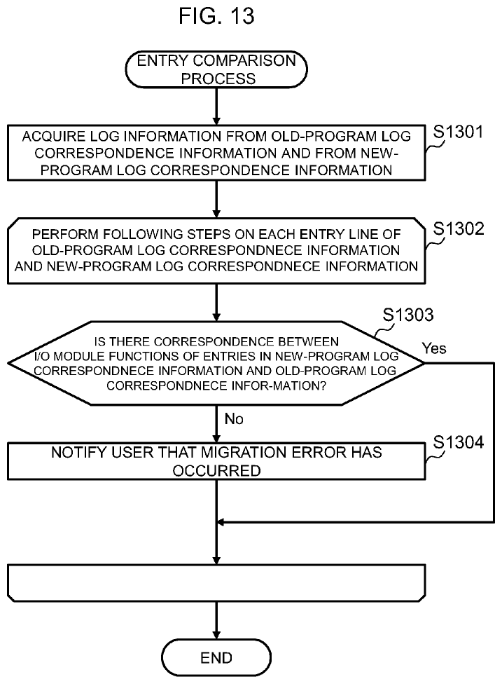

Step S1009 is an entry comparison process. In step S1009, the migration verification processing part 404 performs the entry comparison process in FIG. 13, to be discussed later.

FIG. 11 is a flowchart depicting an exemplary procedure of the log collection process indicated in FIG. 10. The log collection process in FIG. 11 is indicated in the form of a specific procedure in which the management terminal 103 executes the old management script 115 and the external API-A program 106 carries out a request for acquisition of the volume configuration information.

In the depicted example, the steps in the longitudinal direction on the left are performed by the external API-A program 106; the steps in the longitudinal direction in the middle are carried out by the internal management program A 108; and the steps in the longitudinal direction on the right are conducted by the I/O module control program 112.

In step S1101, the external API-A program 106 receives an API for acquisition of the volume configuration information from the management terminal 103. In step S1102, the external API-A program 106 requests the internal management program A 108 to acquire the volume configuration information. Here, the external API-A program 106 may convert the received request to at least one internal request for use in the storage apparatus 101 or convert the data structure corresponding to the request.

In step S1103, the internal management program A 108 receives a request for acquisition of the volume configuration information from the external API-A program 106. In step S1104, the internal management program A 108 requests the I/O module control program 112 to acquire the volume configuration information. Here, the internal management program A 108 may convert the received request to at least one internal request for use in the storage apparatus 101 or convert the data structure corresponding to the request.

In step S1105, the I/O module control program 112 receives the request for acquisition of the volume configuration information from the internal management program A 108. In step S1106, the I/O module control program 112 acquires from the volume configuration information table 304 the entry corresponding to the request for acquisition of the volume configuration information.

In step S1107, the I/O module control program 112 prepares the entry in the I/O module log 300, thereby outputting log information indicating that acquisition of the volume configuration information is completed.

In step S1108, the I/O module control program 112 transmits the acquired volume configuration information to the internal management program A 108. Here, the I/O module control program 112 may convert the data structure of the entries in the acquired volume configuration information, for example.

In step S1109, the internal management program A 108 receives the volume configuration information from the I/O module control program 112. In step S1110, the internal management program A 108 prepares the entry in the internal management program A log 407, thereby outputting log information indicating that acquisition of the volume configuration information is completed.

In step S1111, the internal management program A 108 transmits the acquired volume configuration information to the external API-A program 106. Here, the internal management program A 108 may convert the data structure of the information concerning the entries in the acquired volume configuration information, for example.

In step S1112, the external API-A program 106 receives the volume configuration information from the internal management program A 108. In step S1113, the external API-A program 106 prepares the entry in the external API-A log 405, thereby outputting log information indicating that acquisition of the volume configuration information is completed.

In step S1114, the external API-A program 106 outputs the volume configuration information to the management terminal 103. The above steps make up the process carried out when the old management script 115 is executed on the management terminal 103.

The log collection process in FIG. 11 is only an example. In another example, the log output timing may be different from that in the above-described process. For instance, the logs may be output at the timing when the external API-A program 106, the internal management program A, and the I/O module control program each receive the request for acquisition of the configuration information.

In contrast, when the new management script 116 is executed on the management terminal 103 to carry out the various APIs of the external API-B program 107, the external API-B program 107, various internal management programs 108 and 109, and the I/O module control program 112 perform steps, not indicated, that are similar to those depicted in FIG. 11.

FIG. 12 is a flowchart depicting an exemplary procedure of the process for preparing old-program log correspondence information indicated in FIG. 10 (step S1004). This preparation process is carried out by the migration verification program 110.

In step S1201, the migration verification processing part 404 of the migration verification program 110 acquires various kinds of log information from the external API-A log 405, the internal management program log information, and the I/O module log 300. Here, the timestamps of the various kinds of log information are verified to determine the timestamp recorded upon switchover to the old-script execution mode and the timestamp recorded upon switchover to the new-script execution mode. Only the logs recorded between these two timestamps are extracted.

In step S1202, the migration verification processing part 404 sorts the extracted various kinds of log information in ascending order of timestamps. Steps S1203 through S1209 are carried out repeatedly on each log until all logs have been processed.

In step S1203, the migration verification processing part 404 verifies whether the log information is that of the I/O module 105. In the case where the log information is verified to be the log of the I/O module 105, the migration verification processing part 404 performs step S1204. On the other hand, in the case where the log information is not that of the I/O module 105, the migration verification processing part 404 performs step S1205.

In step S1204, the migration verification processing part 404 adds the function information from the log information of the I/O module 105 to the I/O module function of the current entry in the old-program log correspondence information. The migration verification processing part 404 then returns to and carries out step S1203.

In step S1205, the migration verification processing part 404 verifies whether the log information is that of the internal management program A. In the case where the log information is verified to be the log of the internal management program A, the migration verification processing part 404 performs step S1206. On the other hand, in the case where the log information is not that of the internal management program A, the migration verification processing part 404 performs step S1207. Although what is discussed here is only the case of the internal management program A, this step applies to similar processes performed on various internal management programs. In this flowchart, the processes other than that on the internal management program A are omitted.

In step S1206, the migration verification processing part 404 adds the operation, resource, and parameter information from the log of the internal management program A to an internal API of the current entry in the old-program log correspondence information. The migration verification processing part 404 then returns to and carries out step S1205.

In step S1207, the migration verification processing part 404 verifies whether the log information is that of the external API-A log 405. In the case where the log information is verified to be the log of the external API-A log 405, the migration verification processing part 404 performs step S1208. On the other hand, in the case where the log information is not that of the external API-A log 405, the migration verification processing part 404 goes to and carries out step S1209.

In step S1208, the migration verification processing part 404 adds the method, URL, and parameter information from the external API-A log 405 to an external API of the current entry in the old-program log correspondence information. The migration verification processing part 404 then returns to and carries out step S1207.

In step S1209, the migration verification processing part 404 increments the added entry in the old-program log correspondence information. When the migration verification processing part 404 finishes carrying out steps S1203 through S1209 on all logs extracted in step S1202, the migration verification processing part 404 terminates the process of preparing the old-program log correspondence information.

Meanwhile, the process of preparing the new-program log correspondence information is approximately similar to the above-described old-program log correspondence information preparation process in FIG. 12. That is, when extracting the logs in step S1201, the migration verification program 110 verifies the timestamps of the various kinds of log information to determine the timestamp recorded upon switchover to the old-script execution mode and the timestamp recorded upon switchover to the new-script execution mode. Only the logs recorded between these two timestamps are extracted. Thereafter, in the flowchart indicated in FIG. 12, the migration verification program 110 replaces the external API-A program 106 with the external API-B program 107 and the internal management program A with the internal management program B, and carries out steps similar to those in FIG. 12.

The flowchart indicated in FIG. 12 is only an example. In comparing the timestamps of the various kinds of log information, some other suitable method may be adopted to output the various kinds of log information. For example, in the case where the external API-A program 106, the internal management program A 108, and the I/O module 105 output their logs upon receipt of the request for acquisition of the configuration information, steps S1203, S1204, S1205, S1206, S1207, and S1208 may be carried out in an alternative order of steps S1207, S1208, S1205, S1206, S1203, and S1204. Steps S1203 through S1208 may alternatively be changed as desired in terms of sequence when carried out.

FIG. 13 is a flowchart depicting an exemplary procedure of the entry comparison process indicated in FIG. 10. In step S1301, the migration verification processing part 404 acquires the log information from the old-program log correspondence information 400 and from the new-program log correspondence information 401.

In step S1302, the migration verification processing part 404 performs steps S1303 and S1304 on each entry line of the old-program log correspondence information 400 and of the new-program log correspondence information 401, until the old-program log correspondence information 400 and the new-program log correspondence information 401 have all been processed.

In step S1303, the migration verification processing part 404 checks whether there is correspondence between the I/O module functions of the entries in the old-program log correspondence information 400 and in the new-program log correspondence information 401, for example. That is, in the case where there is correspondence between a first instruction as an exemplary entry in the new-program log correspondence information 401 and a second instruction and the above-mentioned predetermined condition for correspondence is thereby satisfied, the migration verification processing part 404 determines that migration is successfully performed from the old script, i.e., an exemplary entry in the old-program log correspondence information 400, to the new script. In the case where both entries correspond with each other, the migration verification processing part 404 performs step S1302, and in the case where the two entries fail to correspond with each other, the migration verification processing part 404 carries out step S1304.

In step S1304, the migration verification processing part 404 notifies the management terminal 103 used by the user that a migration error has occurred. That is, in the case where the first instruction fails to satisfy the predetermined condition for correspondence in relation to the second instruction, the migration verification program 110 gives a notification that a migration error has occurred as an example of error.

When the migration verification processing part 404 finishes carrying out step S1303 and S1304 on all entries in the old-program log correspondence information 400 and the new-program log correspondence information 401, the migration verification processing part 404 terminates the entry comparison process.

In this embodiment, as described above, the storage apparatus 101 includes at least one drive apparatus capable of storing data, to be discussed later. In response to execution of at least one script, the storage apparatus 101 operates the drive apparatus with respect to the data stored therein. The storage apparatus 101 stores old programs (e.g., external API-A program 106 and internal management program A 108) to be invoked and executed by an old script from among scripts, new programs (e.g., external API-B program 107 and internal management program B 109) to be invoked and executed by a new script from among the scripts, the I/O module control program 112 that controls a first operation on the drive 212 in response to execution of a first instruction (function) corresponding to a request from an old program, the I/O module control program 112 further controlling a second operation (function) on the drive 212 in response to execution of a second instruction corresponding to a request from a new program, and the migration verification program 110 which, when the first instruction satisfies a predetermined condition for correspondence in relation to the second instruction, determines that migration is successfully performed from the old script to the new script.

In the manner described above, operation verification is efficiently performed with respect to the migration of the interface from the old program to the new program.

In this embodiment, in the case where there is correspondence between the first instruction as an exemplary entry in the new-program log correspondence information 401 on one hand and the second instruction on the other hand and the above-mentioned predetermined condition for correspondence is thereby satisfied, the migration n verification processing part 404 determines that migration is successfully performed from the old script, i.e., an exemplary entry in the old-program log correspondence information 400, to the new script. As described, when the condition for correspondence is suitably established, it is possible to effectively perform operation verification to see whether migration from the old script to the new script is successfully executed on the management terminal 103 in a manner satisfying the predetermined condition for correspondence.

This embodiment has two modes: the old-script execution mode as an example of a pre-migration mode in which the old programs are executed in accordance with the old script and the new-script execution mode as an example of a post-migration mode in which the new programs are carried out in accordance with the new script. The migration verification program 110 switches between the old-script execution mode and the new-script execution mode to determine whether migration from the old script to the new script is successfully carried out. In this manner, by switching between the modes, the migration verification program 110 can determine whether migration is successfully performed from the old script to the new script.

In this embodiment, the above-mentioned old programs include two program: the external API-A program 106 as an example of the first external management program to be invoked and executed by the pre-migration old script among the scripts, and the internal management program A 108 as an example of the first internal management program to be invoked and executed by the external API-A program 106. The above-mentioned new programs include two programs: the external API-B program 107 as an example of the second external management program to be invoked and executed by the new script replacing the old one among the scripts, and the internal management program B 109 as an example of the second internal management program to be invoked and executed by the external API-B program 107. This makes it possible to concurrently verify whether migration is successfully performed on the external management programs and on the internal management programs discussed above.

In this embodiment, the management information 111 includes the log information A 111A as an example of the first activity log information corresponding to the above-mentioned first operation and the log information B 111B as an example of the second activity log information corresponding to the above-described second operation. The management information 111 further includes the third activity log information corresponding to the execution of the first instruction by the I/O module control program 112 as an example of the operation control part, and the I/O module log 300, to be discussed later, as an example of the fourth activity log information corresponding to the execution of the second instruction by the I/O module control program 112. In this manner, the log information may be used further to verify accurately whether the above-described migration is successfully performed.

In this embodiment, in the case where the first instruction fails to satisfy the predetermined condition for correspondence in relation to the second instruction, the migration verification program 110 gives a notification that a migration error has occurred as an example of error. This makes it possible reliably to recognize from the outside that the migration from the old script to the new script on the management terminal 103 has failed.

### (2) Second Embodiment

The storage system as a second embodiment of the present invention is configured and operates approximately in the same manner as the storage system 100 of the first embodiment. Thus, the description that follows will focus on what makes the second embodiment different from the first embodiment and will omit similarities in configuration and operation therebetween.

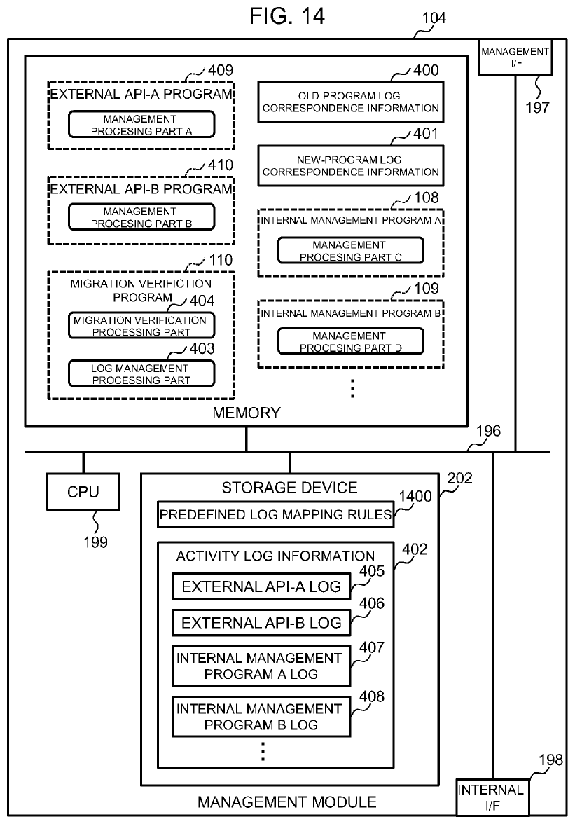

FIG. 14 is a schematic view depicting an exemplary logical configuration of the management module 104 in the second embodiment. The second embodiment differs from the first embodiment in that the storage device 202 of the management: module 104 stores predefined log mapping rules 1400.

In the above-described first embodiment, the migration verification processing part 404 in step S1303 of FIG. 13 determines that migration is successfully performed only in the case where the I/O module function as one of the entries in the new-program log correspondence information 401 corresponds with the I/O module function as one of the entries in the old-program log correspondence information 400. In the second embodiment, by contrast, the migration from the old API to the new API is determined to be successfully performed when the two entries failing to correspond with each other nevertheless fall within a range defined beforehand by the predefined log mapping rules 1400.

That is, in step S1303 (see FIG. 13) of the above-described first embodiment, even though a simple comparison of the I/O module functions of the entries between the new-program log correspondence information 401 and the old-program log correspondence information 400 fails to determine whether migration is successfully performed, at least one predefined additional rule entry permits determination of the successful migration from the old API to the new API.

In this embodiment, the predefined log mapping rules 1400 constitute an exemplary rule management part. At least one rule is predefined with respect to the range in which correspondence is estimated to exist between the above-described third activity log information and the I/O module log 300 as an example of the fourth activity log information. Here, at least one rule is defined beforehand in the predefined log mapping rules 1400.

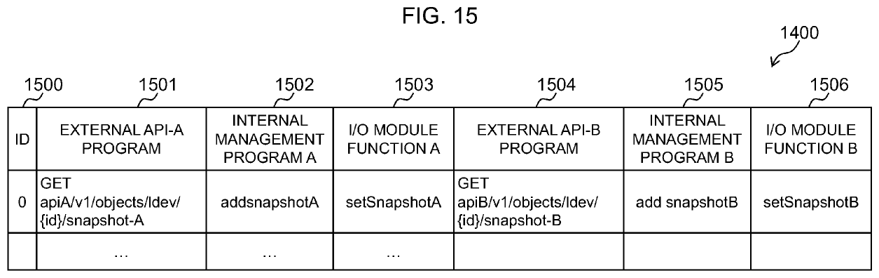

FIG. 15 is a tabular view listing an example of the predefined log mapping rules 1400 indicated in FIG. 14. An entry in the predefined log mapping rules 1400 is prepared, for example, at the timing at which information input by the user from the management terminal 103 is turned into an entry by the migration verification processing part 404 upon receipt of the user-input information from the management terminal 103.

The predefined log mapping rules 1400 manage an external API-A program column 1501, an internal management program A column 1502, an I/O module function A column 1503, an external API-B program column 1504, an internal management program B column 1505, and an I/O module function B column 1506. The predefined log mapping rules 1400 manage the mapping rules on the identities of various external APIs, various internal management programs, and I/O module functions.

For example, the predefined log mapping rules 1400 manage the first instruction as the function corresponding to the request from the above-mentioned old program (e.g., “GET . . . ” in the external API-A program column 1501, “add snapshot A” in the internal management program A column 1502), the second instruction as the function corresponding to the request from the above-described new program (e.g., “GET . . . ” in the external API-B program column 1504, “add snapshot B” in the internal management program B column 1505), the first operation corresponding to the first instruction (e.g., “set Snapshot A” in the I/O module function A column 1503), and the second operation corresponding to the second instruction (e.g., “set Snapshot B” in the I/O module function B column 1506).

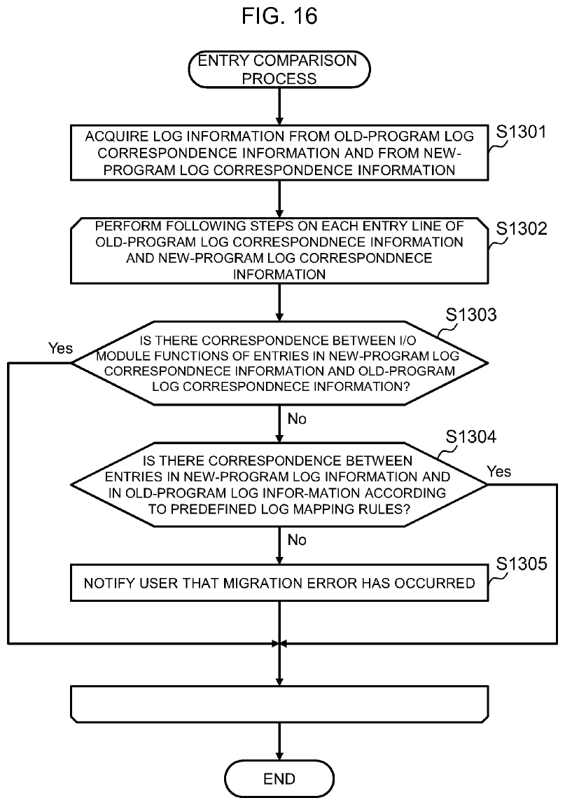

The mapping rules indicated here are exceptional rules predefined by the user regarding the case where a simple comparison of the I/O module functions fails to determine whether migration is successful, as in the flowchart of the migration verification process in FIG. 16, to be discussed later.

The external API-A 1501 records the methods and URLs of the external API-A program 106. The internal API-A 1502 records the operations and resources of the internal management program A.

The I/O module function A 1503 records the names of the I/O module functions executed by the I/O module control program 112 in the storage apparatus 101 when the above-mentioned external API-A is invoked.

The external API-B 1504 records the methods and URLs of the external API-B program 107. The internal API-B 1505 records the operations and resources of the internal management program B. The I/O module function B 1506 records the names of the I/O module functions executed by the module control program 112 in the storage apparatus 101 when the above-mentioned API-B is invoked.

Although not listed, the predefined log mapping rules 1400 may include mapping rules other than those explained above provided that the additional rules constitute information for determining whether the migration is successful in the flowchart of FIG. 16.

In this embodiment, the predetermined conditions for correspondence are not limited to those discussed above. Alternatively, a suitable combination of the columns in FIG. 15 may be used as the condition for correspondence.

FIG. 16 indicates an exemplary flowchart of the migration verification process performed by the second embodiment. In the flowchart of FIG. 16, the steps approximately the same as those in the above-described flowchart of FIG. 13 for the first embodiment are designated by the same reference signs.

In step S1301, the migration verification processing part 404 acquires the log information from the old-program log correspondence information 400 and from the new-program log correspondence information 401.

In step S1302, the migration verification processing part 404 performs steps S1303 through S1305 on each entry line of the old-program log correspondence information 400 and of the new-program log correspondence information 401, until the old-program log correspondence information 400 and the new-program log correspondence information 401 have all been processed.

In step S1303, the migration verification processing part 404 makes a comparison between the I/O module function as one entry in the new-program log correspondence information 401 (simply referred to as an “entry” hereunder) and the I/O module function as one entry in the old-program log correspondence information 400 (simply referred to as an “entry”), in order to check whether the two entries correspond with each other. In the case where the two entries correspond with each other, the migration verification processing part 404 carries out step S1302. The steps up to this point are similar to those of the first embodiment. On the other hand, in the case where the two entries fail to correspond with each other, the migration verification processing part 404 performs step S1304.

In step S1304, the migration verification processing part 404 checks whether there is correspondence between the entry in the new-program log correspondence information 401 and the entry in the old-program log correspondence information 400 according to the rules predefined as the entries in the predefined log mapping rules 1400. In the case where the two entries are determined to correspond with each other under the rules of the predefined log mapping rules 1400, the migration verification processing part 404 performs step S1302. On the other hand, in the case where the two entries are determined not to correspond with each other, the migration verification processing part 404 performs step S1305.

In step S1305, as in the above-described first embodiment, the migration verification processing part 404 notifies the management terminal 103 that a migration error has occurred.

When the migration verification processing part 404 finishes carrying out steps S1303 through S1305 on all entries of the old-program log correspondence information 400 and of the new-program log correspondence information 401, the migration verification processing part 404 terminates this entry comparison process.

In this embodiment, the predefined log mapping rules 1400 are an example of the rule management part. At least one rule is predefined with respect to the range in which correspondence is estimated to exist between the above-described third activity log information and the I/O module log 300 as an example of the fourth activity log information. In that range, for example, Snapshot A and Snapshot B may be determined to correspond with each other as functions. When the conditions for correspondence are established with margins of tolerance in this manner, it is possible to determine whether migration from the old script to the new script is successfully performed not only in the case where the first instruction corresponds with the second instruction but also within margins of tolerance of the rules on correspondence.

In this embodiment, at least one rule is predefined in the predefined log mapping rules 1400. Predefining desired rules in this manner in the predefined log mapping rules 1400 make it possible to determine whether migration from the old script to the new script is successful within margins of tolerance of the rules.

In this embodiment, the predefined log mapping rules 1400 manage, for example, the first instruction (e.g., “GET . . . ” in the external API-A program column 1501, “add snapshot A” in the internal management program A column 1502) corresponding to the request from the above-mentioned old program, the second instruction (e.g., “GET . . . ” in the external API-B program column 1504, “add snapshot B” in the internal management program B column 1505) corresponding to the request from the above-described new program, the first operation (e.g., “set Snapshot A” in the I/O module function A column 1503) corresponding to the first instruction, and the second operation (e.g., “set Snapshot B” in the I/O module function B column 1506) corresponding to the second instruction.

It is to be noted that the present invention is not limited to the embodiments discussed above and includes diverse variations and equivalents within the scope of the appended claims. For example, the foregoing embodiments are intended to provide detailed explanations promoting easy understanding of the present invention. This invention is thus not necessarily limited to any embodiment having all the constituents explained above. The elements described in parallel in the foregoing embodiments may be configured in such a manner that at least one element is serially connected to another element.

The present invention can thus be applied to a storage apparatus related to the technology of verifying the migration between scripts that use multiple APIs offered to users by the storage apparatus.

What is claimed is:

1. A storage apparatus having at least one drive apparatus that is able to store data and operating the drive apparatus with respect to the data therein in response to execution of at least one script, the storage apparatus comprising:
an old program invoked and executed by a pre-migration script among the scripts;
a new program invoked and executed by a post-migration script among the scripts;
an operation control part configured to control a first operation on the drive apparatus in response to execution of a first instruction corresponding to a request from the old program, the operation control part further controlling a second operation on the drive apparatus in response to execution of a second instruction corresponding to a request from the new program; and
a migration verification part configured such that, in a case where the first instruction satisfies a predetermined condition for correspondence in relation to the second instruction, the migration verification part determines that migration from the pre-migration script to the post-migration script is successfully performed.

2. The storage apparatus according to claim 1, wherein, in a case where the first instruction corresponds with the second instruction and the predetermined condition for correspondence is thereby satisfied, the migration verification part determines that migration from the pre-migration script to the post-migration script is successfully performed.

3. The storage apparatus according to claim 1, further comprising:
a pre-migration mode in which the old program is executed in accordance with the pre-migration script; and
a post-migration mode in which the new program is executed in accordance with the post-migration script,
wherein the migration verification part switches between the pre-migration mode and the post-migration mode to determine whether migration from the pre-migration script to the post-migration script is successfully performed.

4. The storage apparatus according to claim 1, wherein
the old programs include
a first external management program invoked and executed by the pre-migration script among the scripts, and
a first internal management program invoked and executed by the first external management program, and
the new programs include
a second external management program invoked and executed by the post-migration script replacing the pre-migration script among the scripts, and
a second internal management program invoked and executed by the second external management program.

5. The storage apparatus according to claim 1, further comprising:
management information that includes first activity log information corresponding to the first operation, second activity log information corresponding to the second operation, third activity log information corresponding to execution of the first instruction by the operation control part, and fourth activity log information corresponding to execution of the second instruction by the operation control part.

6. The storage apparatus according to claim 5, further comprising:
a rule management part configured to have at least one rule predefined therein regarding a range in which correspondence is estimated to exist between the third activity log information and the fourth activity log information,
wherein the migration verification part estimates that correspondence exists between the third activity log information and the fourth activity log information even in a case where the third activity log information fails to correspond with the fourth activity log information.

7. The storage apparatus according to claim 1, wherein, in a case where the first instruction fails to satisfy the predetermined condition for correspondence in relation to the second instruction, the migration verification part gives a notification that an error has occurred.

8. The storage apparatus according to claim 6, wherein the rule management part has the at least one rule predefined therein.

9. The storage apparatus according to claim 6, wherein the rule management part manages the first instruction corresponding to the request from the old program, the second instruction corresponding to the request from the new program, the first operation corresponding to the first instruction, and the second operation corresponding to the second instruction.

10. A migration verification method for use with a storage apparatus having at least one drive apparatus that is able to store data and operating the drive apparatus with respect to the data therein in response to execution of at least one script, the migration verification method comprising:
an old program invoked and executed by a pre-migration script among the scripts;
a new program invoked and executed by a post-migration script among the scripts;
an operation control part configured to control a first operation on the drive apparatus in response to execution of a first instruction corresponding to a request from the old program, the operation control part further controlling a second operation on the drive apparatus in response to execution of a second instruction corresponding to a request from the new program; and
a migration verification part configured such that in a case where the first instruction satisfies a predetermined condition for correspondence in relation to the second instruction, the migration verification part determines that migration from the pre-migration script to the post-migration script is successfully performed.
